(19) United States
(12) Patent Application Publication
(10) Pub. No.: US 2007/0122227 A1
(43) Pub. Date: May 31, 2007

(54) ASSEMBLY FOR MOUNTING PAINT SPRAY GUN TO EXTENSION POLE WITH PAINT APPLICATOR

(75) Inventor: Kurtis J. Davis, Mission, KS (US)

Correspondence Address: HOVEY WILLIAMS LLP, 2405 GRAND BLVD., SUITE 400, KANSAS CITY, MO, 64108, US

(73) Assignee: COATINGS MANAGEMENT SYSTEMS, INC., Mission, KS (US)

(21) Appl. No.: 11/164,610

(22) Filed: Nov. 30, 2005

(51) Int. Cl. A47L 13/00; B43M 11/02

(52) U.S. Cl. 401/137; 401/219

(57) ABSTRACT

A paint applicator (10) for application of paint to a surface (20) is provided which includes a telescopic pole (12) supporting a paint applicator (14) (e.g., a paint roller (28)) and a paint sprayer (16). The sprayer (16) is detachably secured to pole (12) by means of adjustable mounting assembly (48) and is operatively connected with an operating lever (92) also supported on pole (12) through assembly (50). The assemblies (48, 50) and sprayer (16) may be retrofitted onto otherwise conventional pole-type paint applicators. The applicator (10) may be operated by a single user to selectively spray paint onto the surface (20) as needed while appropriately spreading the paint using applicator (14).

### BACKGROUND OF THE INVENTION

1. Field of the Invention

The present invention is broadly concerned with paint application equipment, such as pole-type paint application assemblies having both a spreading device (e.g., a roller or pad) together with a pole-mounted selectively operable paint sprayer. More particularly, the invention is concerned with such application assemblies wherein a trigger-operated spray gun is mounted to the extension pole adjacent the paint applicator. The present invention is particularly useful as a retrofit onto a conventional pole-type paint applicator, although the principles of the invention are not so limited.

2. Description of the Prior Art

It has long been recognized that extending a user's reach through an extension pole is advantageous in painting wall or ceiling surfaces. A paint roller mounted on a pole allows the user to work beyond his or her natural reach and thus makes a painting job easier and more efficient.

In recent years, paint rollers have been provided which have a tubular handle and an optional tubular extension pole which are designed to convey paint through the pole and handle to a specially designed roller. In this regard, paint must flow in passageways in the pole and roller frame and pass through a uniquely designed roller cover. Those ordinarily skilled in the art will appreciate that such a configuration is particularly problematic when changing paint colors or types. Furthermore, as with all reusable painting equipment, the device must be thoroughly cleaned after use; however, the unique construction and paint passageways cause such cleaning thereof to be time consuming and tedious.

Another type of paint application assembly utilizes a tubular handle with a distally mounted paint applicator and an adjacent sprayer. The sprayer communicates with a passageway in the pole, such that paint is supplied through the pole and through the sprayer. Here again, these units are relatively expensive and present problems similar to those noted above.

It has also been known in the past to equip an extendable pole with a paint sprayer. For example, U.S. Pat. No. 6,378,922 describes such a device having an accessory (which presumably could comprise a paint spray head) mounted adjacent the distal end of a telescoping pole. The device includes an operating lever adjacent the opposite distal end of the pole to selectively actuate the accessory. However, this type of pole mechanism is of complicated design and has several shortcomings. For example, the device depicted in the '922 patent is not suitable for use with a standard trigger-operated paint sprayer. Nor does the device show or suggest the use of a paint applicator on the pole. Finally, the device is not suitable for use in retrofit applications, where an existing extension pole is converted for use with the proximally controlled but distally mounted accessory.

### SUMMARY OF THE INVENTION

The present invention overcomes the problems outlined above and provides a paint application assembly that is particularly in applying paint to a surface using preexisting trigger-controlled paint sprayers.

In particularly, according to one aspect of the present invention, a paint application assembly comprises an elongated pole presenting opposite proximal and distal ends. The assembly further includes a paint applicator secured to said pole adjacent the distal end thereof, as well as a sprayer mounting assembly detachably securing a trigger-controlled sprayer to the pole adjacent the distal end thereof in order to emit paint in proximity to the applicator. The mounting assembly includes a shiftable element selectively engageable with the trigger to control actuation thereof. The mounting assembly further includes a manually operable actuator adjacent the proximal end of the pole, with the actuator and element being operably interconnected so that the actuator is operable to control actuation of the sprayer trigger.

Another aspect of the present invention concerns a mounting assembly permitting detachable mounting of a trigger-controlled paint sprayer onto an elongated pole provided with a distally mounted paint applicator. The mounting assembly comprises a clamp operable for detachable connection to the pole. The clamp supports a mounting element for receiving the sprayer and a shiftable element selectively engageable with the trigger to control actuation thereof. The mounting assembly further comprises an actuating assembly for detachable connection to the pole. The actuating assembly includes a manually operable actuator and a coupler extending from the actuator to the shiftable element so that the actuator is operable control actuation of the trigger.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective view of a paint application assembly constructed in accordance with a preferred embodiment of the present invention, with the assembly being shown during application of paint to a wall surface;

FIG. 2 is a fragmentary, enlarged perspective view of the application assembly illustrated in FIG. 1;

FIG. 3 is a fragmentary side view of the application assembly shown in FIGS. 1-2, showing the assembly in its non-spray condition with the lever actuator released;

FIG. 4 is a fragmentary side view similar to that of FIG. 3, but illustrating operation of the assembly upon actuation of the manual actuating lever;

FIG. 5 is a fragmentary side view of the application assembly depicted in FIG. 4, but showing the sprayer oriented to apply paint directly to the surface of the paint roller;

FIG. 6 is a fragmentary, enlarged, exploded view of the assembly, illustrating the components of the preferred pole mounting assembly for the paint sprayer;

FIG. 7 is a fragmentary, enlarged, exploded view similar to that of FIG. 6, but showing the components from the side opposite that of FIG. 6; and

FIG. 8 is a fragmentary, enlarged view of the assembly, again illustrating the paint sprayer pole mounting assembly.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENT

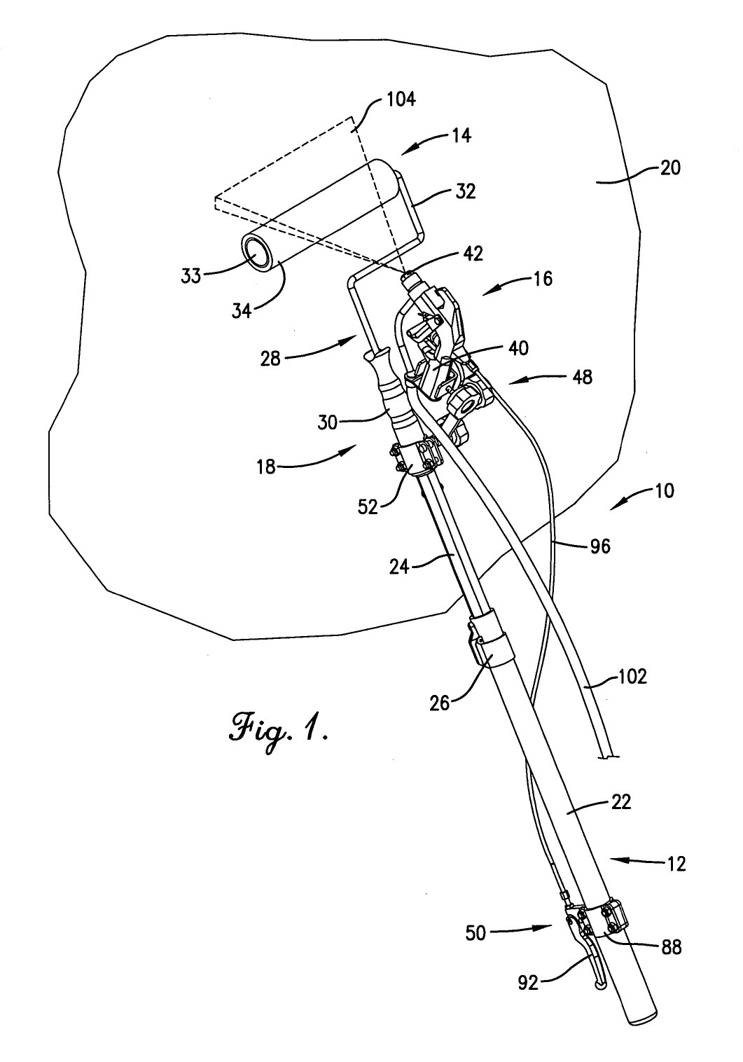

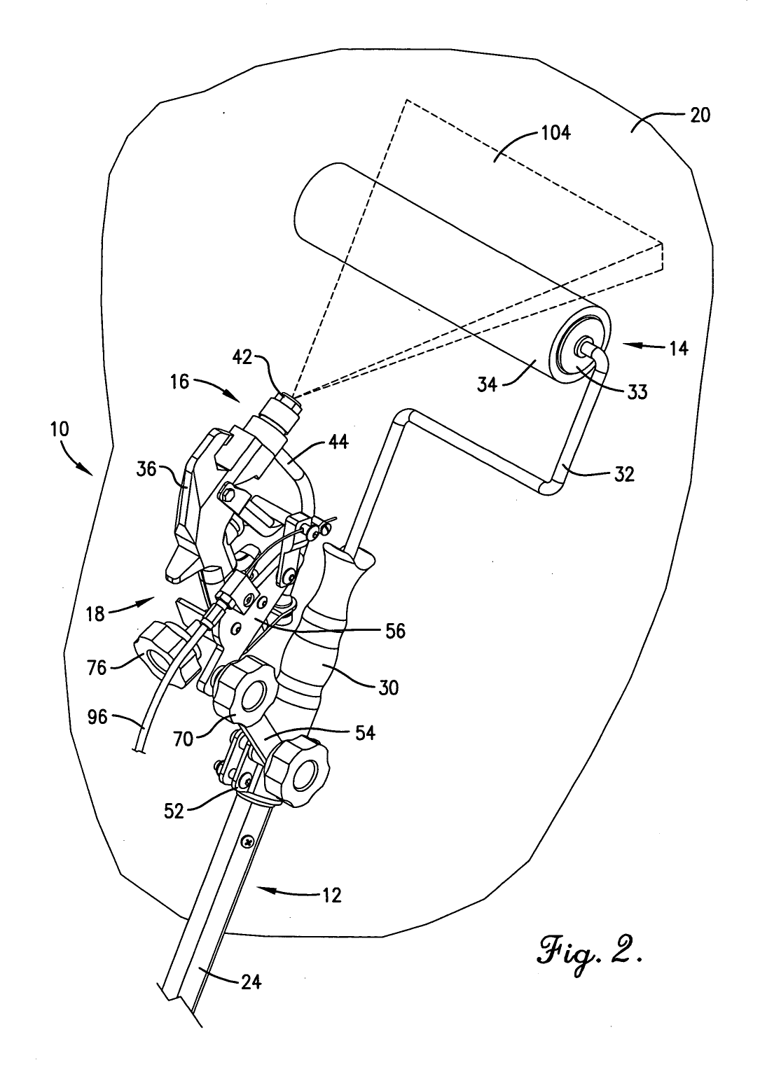

Turning now to the drawings, a paint application assembly 10 is illustrated in FIGS. 1-5 and broadly includes an elongated telescopic pole 12, an end-mounted paint applicator 14, paint sprayer 16, and a mounting assembly 18 for detachably securing the sprayer 16 and associated control structure onto pole 12. The application assembly 10 is designed for rapid and easy application of paint onto a wall surface 20 or the like. A particular feature of the invention is that it permits a standard pole-type painting device to be retrofitted with a conventional sprayer.

In more detail, the pole 12 is itself conventional and includes a pair of telescopically interfitted sections 22 and 24. The section 22 provides a hand grip, whereas the section 24 is designed to support a paint applicator 14 (or other accessory). The pole 12 has a locking mechanism 26 adjacent the upper end of section 22 for locking the section 24 in place at a selected extension length. In this fashion, the pole 12 may be extended to various lengths, at the discretion of the user. Other adjustable length pole configurations are encompassed by the principles of the present invention. Furthermore, those ordinarily skilled in the art will appreciate that the principles of the present invention are not limited to an adjustable length pole. For example, it is entirely within the ambit of the present invention to utilize a fixed length extension handle.

The applicator 14 in the illustrated embodiment is a standard paint roller 28 having a synthetic resin handle 30, a rigid bar-type support 32, and an outermost, rotatable roller 33 covered with a replaceable, paint-spreading roller sleeve 34. As illustrated, the lower end of handle 30 is removably secured to the upper end of pole section 24 by threading or other conventional means. If desired, the applicator 14 can alternatively be permanently affixed to the pole 12. Furthermore, it will be appreciated that a variety of other paint applicators, such as flat or corner pads, may be used in lieu of roller 28.

Paint sprayer 16 is in the illustrated embodiment a conventional spray gun 36 having a pistol-type body 38 including handle 40, spray outlet head 42, and paint conveying tube 44 secured to a threaded nipple 45. The body 38 also supports a spring-loaded, pivotally mounted operating component in the form of a trigger 46. The sprayer 16 may be of the airless type, or any other known sprayer design.

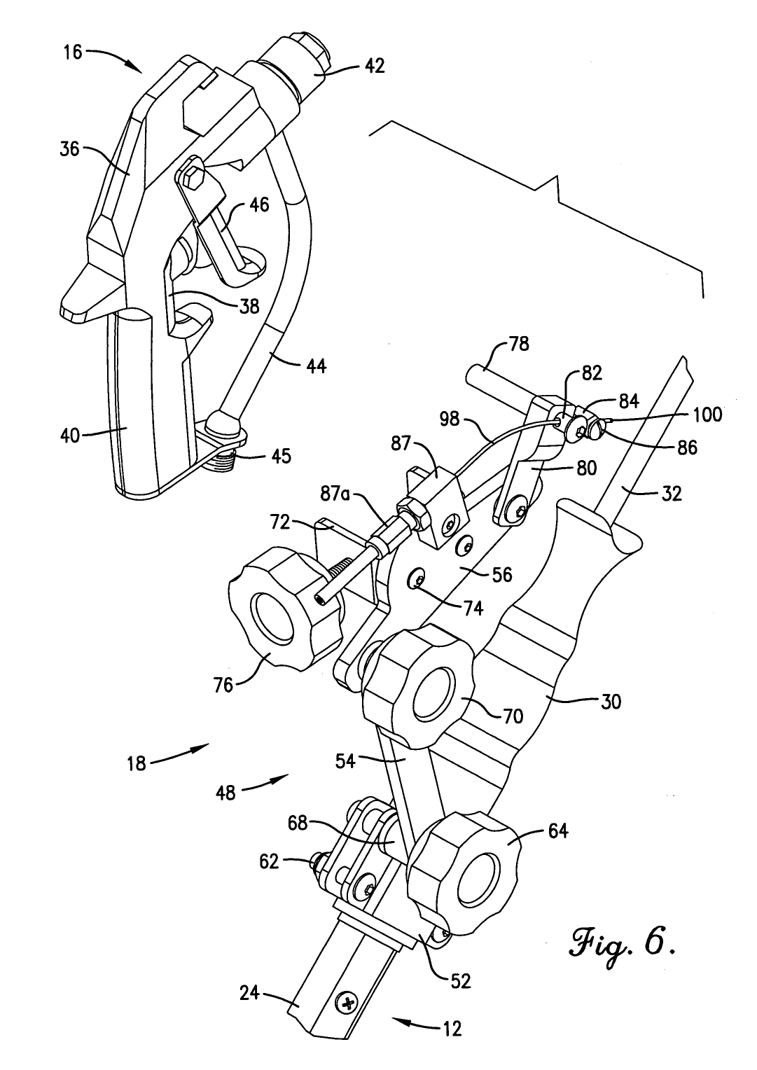

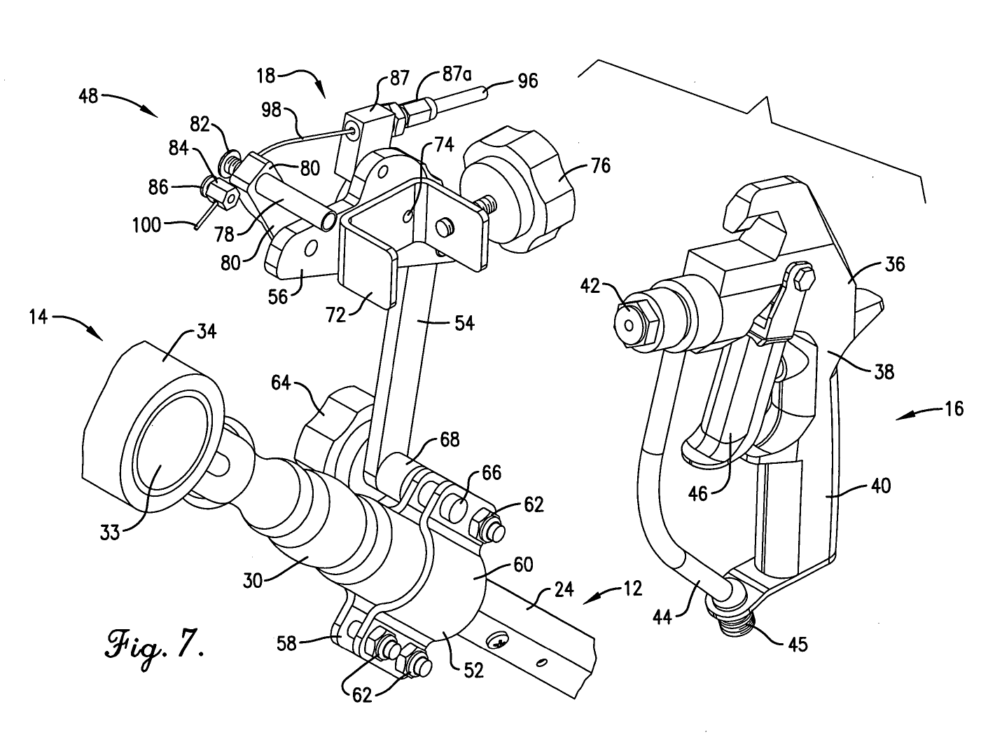

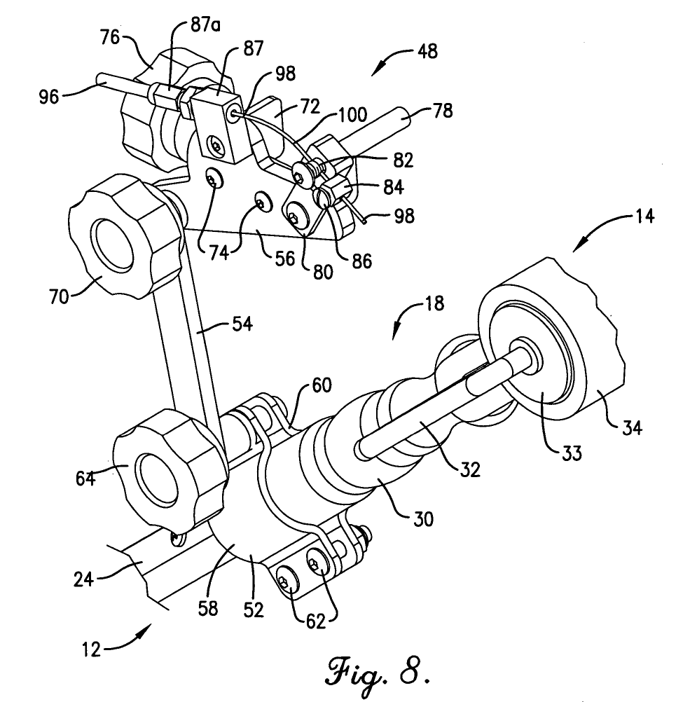

The mounting assembly 18 includes two principal assemblies, namely a sprayer mounting assembly 48 and an actuator assembly 50. The assembly 48 is mounted adjacent the upper end of pole section 24 proximal to paint applicator 14. As best illustrated in FIGS. 6-8, the assembly 48 includes a pole clamp 52, a first extension leg 54, and a sprayer-supporting plate or leg 56 mounted to the outboard end of leg 54. In more detail, the clamp 52 is of two-piece design including clamp halves 58 and 60 disposed about the lowermost end of handle 30 and interconnected by means of nut and bolt assemblies 62. Additionally, the leg 54 is secured to the clamp 52 by means of a tightening knob 64 having a threaded shank 66 extending through the clamp halves 58, 60 (see FIG. 7). As shown, the leg 54 is offset from the clamp 52 by means of annular spacer 68. The second leg 56 is attached to the outboard end of leg 54 by means of a clamping knob 70 having a threaded shank received within a correspondingly threaded opening in leg 56. Tightening of the knob 70 secures leg 56 in a desired orientation relative to leg 54 and pole 12. The knobs 64 and 70 provide respective axes of adjustment for the mounting assembly. Preferably, these axes are substantially parallel to one another and generally transverse relative to the pole axis.

The leg 56 includes hardware for mounting of spray gun 36 and to permit selective actuation thereof. Specifically, the leg 56 supports a generally U-shaped bracket 72, secured in place by means of screws 74. The bracket 72 carries a knob-type set screw 76 as illustrated. Additionally, the leg 56 has a pivotally mounted, rod-type operating element 78. The latter is mounted for pivotal movement on an obliquely oriented pivot arm 80 secured to the forward end of leg 56 by means of an apertured mounting screw 82. The arm 80 also includes an apertured cable set 84 having a tightening screw 86. Finally, an apertured coaxial cable block 87 is fixedly secured to leg 56 and has a coaxial cable mounting assembly 87a.

The actuator mounting assembly is mounted in spaced relationship to the assembly 40 on pole section 22. The assembly 50 includes a two-component clamp 88 identical with pole clamp 52, but has a handle mounting plate 90 secured to one side thereof equipped with a coaxial cable mounting assembly 90a. An operating lever 92 is pivotally supported on the plate 90 via link 94. The overall assembly 50 further includes an automotive-type coaxial coupling cable 96 having a central, metallic, shiftable actuating cable 98. As depicted, the cable 96 is operatively connected to lever 92 by means of assembly 90a and extends upwardly to block 87 where it is secured in place through assembly 87a. A leading segment 100 of the shiftable cable 98 extends through block 87, screw 82, and cable set 84, and is maintained in place by tightening of screw 86. The principles of the present invention are equally applicable to other types of mounting and actuating assemblies, although it is most preferred to have the sprayer 16 adjustably supported on the pole adjacent the applicator 14. For example, a rigid coupling device could interconnect the manual actuator (at the proximal end of the pole) with the sprayer trigger control.

The construction and assembly of application assembly 10 can be readily understood from the foregoing description. A conventional pole-type painting device, including pole 12 and applicator 14, may be retrofitted with the sprayer 16 using mounting assembly 18 to provide enhanced painting utility, although the principles of the present invention are equally applicable to original equipment provided with the mounting assembly for removably supporting the sprayer 16 adjacent the applicator 14. First, the assembly 48 is secured to pole section 24 by installation of the clamp 52 and associated hardware. The assembly 50 is also attached to pole section 24 by means of clamp 88. Next, the cable 96 is installed between the mounting assemblies 90a and 87a, with the cable lead 100 extending through block 87, screw 82, and cable set 84. When it is desired to apply paint using the assembly 10, the spray gun 16 is located with the handle 40 thereof within bracket 72, and set screw 76 is tightened to secure the gun in place. In this orientation, the component 78 is located in close adjacency with the trigger 46 of gun 36. If necessary, the orientation of the first and second legs 54 and 56 is appropriately adjusted using the clamping knobs 64 and 70. In order to operate the application assembly, it is only necessary to attach a conventional paint tube 102 to the threaded nipple 45, with the tube 102 extending to an appropriate supply of paint and pressurization source.

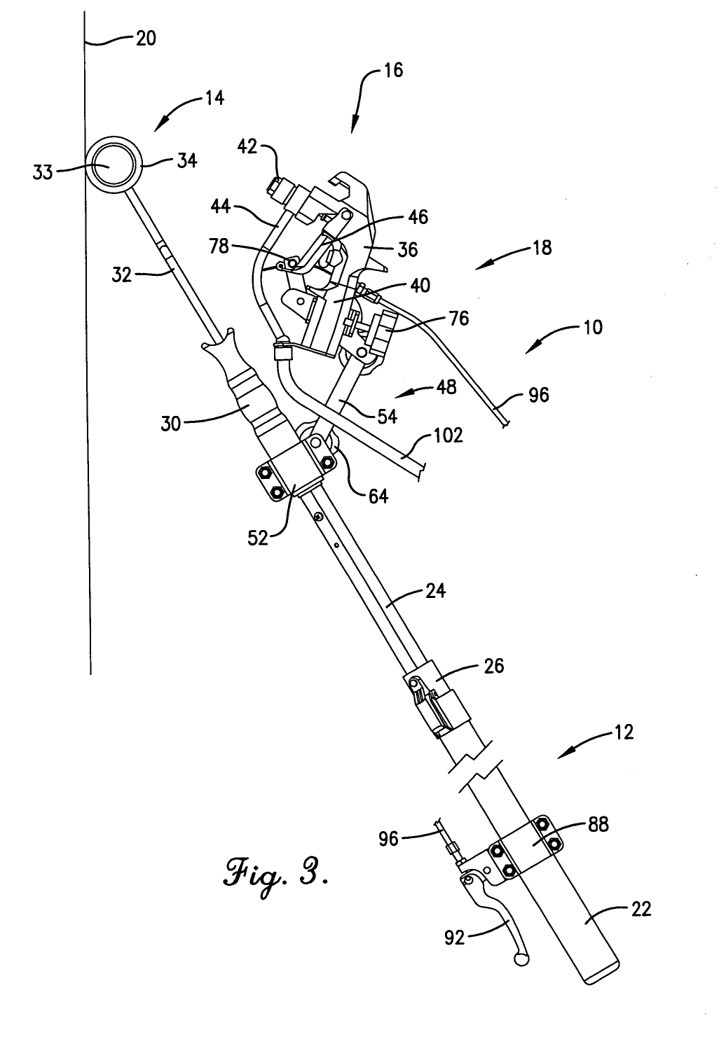

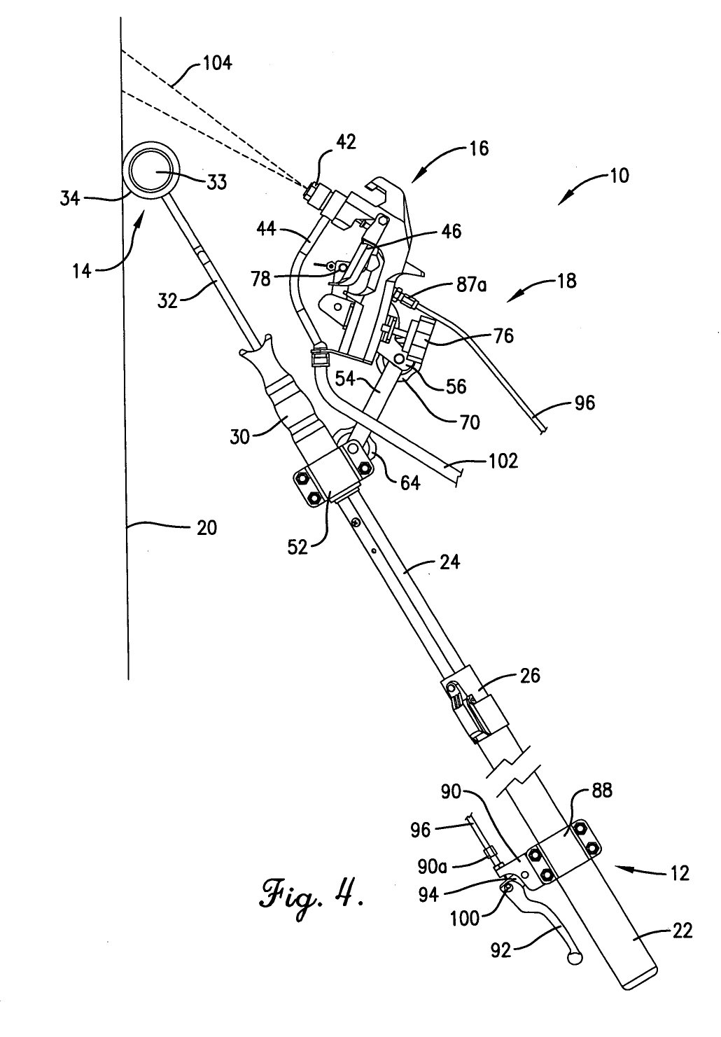

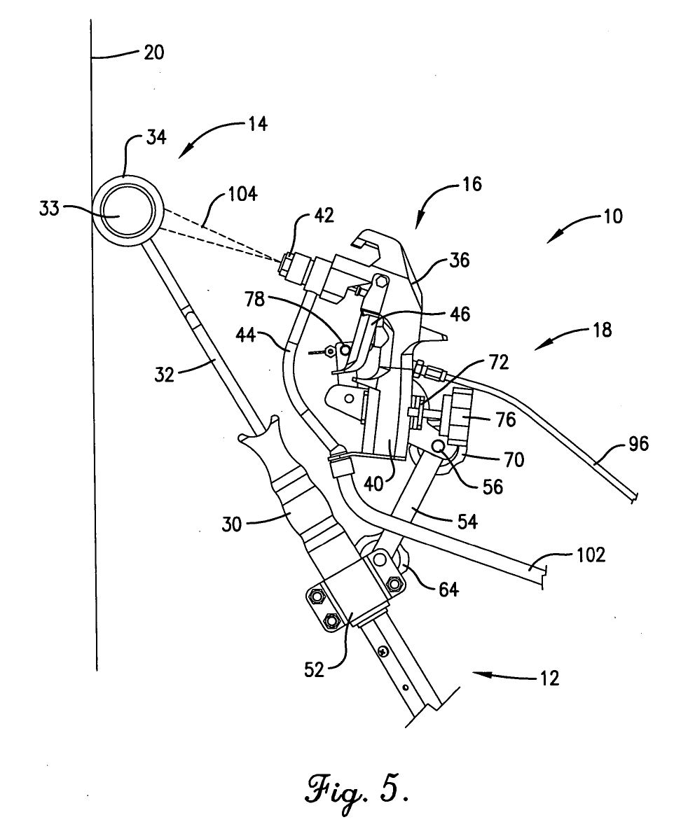

The use of application assembly 10 is illustrated in FIGS. 3 and 4 for example. Specifically, when it is desired to apply paint to the surface 20, user merely grasps and pivots lever 92 thereby effecting retractive movement of the element 78 through the medium of cable 96. Such movement in turn depresses spray gun trigger 46 causing a paint spray pattern 104 to be delivered from head 42 to surface 20. At the same time or thereafter, the user manipulates handle 12 so as to spread the spray-applied paint onto surface 20 using roller 28. It will be appreciated that altering the orientation of gun 36 can be readily accomplished through adjustment of assembly 48. For example, if desired the spray pattern 104 from gun 36 may be aimed for direct application onto roller sleeve 34 (see FIG. 5).

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

Having thus described the preferred embodiment of the invention, what is claimed as new and desired to be protected by Letters Patent includes the following:

What is claimed is:

1. A paint application assembly for use with a trigger-controlled sprayer connectable to a paint source and operable to emit paint when the trigger is actuated, said paint application assembly comprising:
an elongated pole presenting opposite proximal and distal ends;
a paint applicator secured to said pole adjacent the distal end thereof; and
a sprayer mounting assembly detachably securing the sprayer to said pole adjacent the distal end thereof in order to emit paint in proximity to the applicator,
said mounting assembly including a shiftable element selectively engageable with the trigger to control actuation thereof,
said mounting assembly further including a manually operable actuator adjacent the proximal end of the pole, with the actuator and element being operably interconnected so that the actuator is operable to control actuation of the trigger.

2. The paint application assembly as claimed in claim 1,
said mounting assembly being selectively detachable from said pole.

3. The paint application assembly as claimed in claim 1,
said mounting assembly including a mounting element configured for removable connection to the sprayer, with the position of the mounting element relative to the pole being adjustable.

4. The paint application assembly as claimed in claim 3,
said mounting element comprising a U-shaped bracket and a set screw supported by the bracket and engageable with said sprayer in order to hold the sprayer in place.

5. The paint application assembly as claimed in claim 4,
said bracket being adjustable relative to the pole about at least two axes of adjustment.

6. The paint application assembly as claimed in claim 5,
said axes of adjustment being substantially parallel relative to one another and generally transverse relative to a longitudinal axis of the pole.

7. The paint application assembly as claimed in claim 1,
said mounting assembly including a coupler extending from said actuator to said shiftable element.

8. The paint application assembly as claimed in claim 7,
said manually operable actuator comprising a lever,
said coupler comprising an elongated actuating cable secured to said lever and said shiftable element.

9. The paint application assembly as claimed in claim 1,
said mounting assembly including a clamp engageable with said pole, a first leg extending from said clamp, a second leg secured to the first leg, and a mounting element secured to the second leg and configured for removable connection to the sprayer.

10. The paint application assembly as claimed in claim 9,
said mounting assembly including adjustment structure permitting alteration in the orientation of each of said legs respectively.

11. The paint application assembly as claimed in claim 1,
said applicator comprising a paint roller.

12. The paint application assembly as claimed in claim 11,
said paint roller being removably coupled to the pole.

13. The paint application assembly as claimed in claim 1,
said pole being extendable.

14. The paint application assembly as claimed in claim 13,
said pole including telescopically interfitted sections and a locking mechanism configured to permit selective movement of the sections relative to one another.

15. A mounting assembly permitting detachable mounting of a trigger-controlled paint sprayer onto an elongated pole provided with a distally mounted paint applicator, wherein the sprayer is connectable to a paint source and operable to spray paint when the trigger is actuated, said mounting assembly comprising:
a clamp operable for detachable connection to the pole and supporting a mounting element for receiving the sprayer and a shiftable element selectively engageable with the trigger to control actuation thereof; and
an actuating assembly for detachable connection to the pole and including a manually operable actuator and a coupler extending from said actuator to said shiftable element so that the actuator is operable control actuation of the trigger.

16. The mounting assembly as claimed in claim 15,
said mounting element being adjustably positionable relative to the clamp.

17. The mounting assembly as claimed in claim 16,
said mounting element comprising a U-shaped bracket and a set screw supported by the bracket and engageable with said sprayer in order to releasably hold the sprayer in place.

18. The mounting assembly as claimed in claim 17,
said bracket being adjustable relative to the clamp about at least two axes of adjustment.

19. The mounting assembly as claimed in claim 18,
said axes of adjustment being substantially parallel relative to one another.

20. The mounting assembly as claimed in claim 15,
said manually operable actuator comprising a lever,
said coupler comprising an elongated actuating cable secured to said lever and said shiftable element.

21. The mounting assembly as claimed in claim 15;
a first leg extending from said clamp; and
a second leg secured to the first leg, with the mounting element being secured to the second leg.

22. The mounting assembly as claimed in claim 21; and
adjustment structure permitting alteration in the orientation of each of said legs respectively.
